(19) United States
(12) Patent Application Publication
(10) Pub. No.: US 2008/0067207 A1
(43) Pub. Date: Mar. 20, 2008

(54) Pack for Mobile Chair

(75) Inventors: David G. Behrhorst, Evergreen, CO (US); Ann Aukerman Moore, Evergreen, CO (US); Susan Diane Nelson, Highlands Ranch, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Air Lift Unlimited Inc., Evergreen, CO (US)

(21) Appl. No.: 11/854,764

(22) Filed: Sep. 13, 2007

Related U.S. Application Data
(60) Provisional application No. 60/826,057, filed on Sep. 18, 2006.

(51) Int. Cl. B60R 9/00

(52) U.S. Cl. 224/407

(57) ABSTRACT

According to the invention, an apparatus for storing objects is disclosed. The apparatus may include a storage container and an inverted pocket. The storage container may define a plurality of spaces for storing objects, including a first space and a second space. The first space and the second space may each be accessible from either or both of the side of the container and the top of the container. The inverted pocket may be coupled with the storage container, and may couple the storage container with a chair when at least some portion of the back of the chair is inserted into the inverted pocket.

### CROSS-REFERENCE TO RELATED APPLICATIONS

This application claims priority to Provisional U.S. Patent Application No. 60/826,057 filed Sep. 18, 2006, entitled “PACK FOR MOBILE CHAIR,” the entire disclosure of which is hereby incorporated by reference, for all purposes, as if fully set forth herein.

### BACKGROUND OF THE INVENTION

This invention relates generally to personal storage equipment. More specifically the invention relates to storage packs for mobile chairs such as manual wheelchairs, motorized wheelchairs, and personal scooters.

Storage packs that may be used on mobile chairs must be specially configured to allow users of the mobile chairs to efficiently use the storage they provide. Accessibility of the storage may be critical when the user of the chair lacks the mobility to access the pack from any other position than sitting in the chair. Additionally, accessibility needs by others, possibly caretakers for example, must also be taken into account.

Additionally, the wide ranging configurations and sizes of mobile chairs makes sizing of attachment mechanisms such as straps problematic. If very specific configurations of attachment mechanisms are employed, a custom pack must be acquired based on the precise type of mobile chair. If more general configurations are employed that allow the pack to be used with various mobile chairs, the reliability and integrity of the coupling to any one specific chair may decrease the overall quality of the pack.

Furthermore, given the dearth of packs which solve these problems specific to mobile chairs, regular packs, such as traditional backpacks, may be employed by users. These packs fail to take into account other requirements of mobile chair users, such as comfort during extended and continuous periods of use.

Embodiments of the present invention solve these and other problems.

### BRIEF DESCRIPTION OF THE INVENTION

In one embodiment, an apparatus for storing objects is provided. The apparatus may include a storage container and an inverted pocket. The storage container may define a plurality of spaces for storing objects, including a first space and a second space. The first space and the second space may each be accessible from either or both of the side of the container and the top of the container. The inverted pocket may be coupled with the storage container, and may couple the storage container with a chair when at least some portion of the back of the chair is inserted into the inverted pocket.

In another embodiment, a different apparatus for storing objects is provided. The apparatus may include a storage container and an inverted pocket. The storage container may define at least one space for storing objects. The inverted pocket may be coupled with the storage container, and may couple the storage container with a chair when at least some portion of the back of the chair is inserted into the inverted pocket. The inverted pocket may be at least partially made from a material which is more flexible in a widthwise direction of the chair than in the direction of the depth of the inverted pocket.

In another embodiment, an additional apparatus for storing objects is provided. The apparatus may include a storage container and an inverted pocket. The storage container may define at least one space for storing objects. The inverted pocket may be coupled with the storage container, and may couple the storage container with a chair when at least some portion of the back of the chair is inserted into the inverted pocket. At least a portion of the outer side of the inverted pocket may be made from a material which wicks away moisture.

In a further embodiment, another apparatus for storing objects is provided. The apparatus may include a storage container, an inverted pocket, and at least one tightening mechanism. The storage container may define at least one space for storing objects. The inverted pocket may be coupled with the storage container, and may couple the storage container with a chair when at least some portion of the back of the chair is inserted into the inverted pocket. The tightening mechanism or mechanism may be coupled with the storage container and the inverted pocket, and may allow a user to tighten the inverted pocket in around the back of the chair.

Some or all of the features of each of the above described embodiments, along with other features, not limited to those described herein, may be combined in various ways to create other embodiments within the scope of the invention.

### BRIEF DESCRIPTION OF THE DRAWINGS

The present invention is described in conjunction with the appended figures:

FIG. 1 is an axonometric drawing of one of the apparatuses of the invention for storing objects;

FIG. 2 is an axonometric drawing of the apparatus of FIG. 1 coupled with a wheelchair; and

FIG. 3 is a reverse view of FIG. 2 with a person sitting in the wheelchair.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing an exemplary embodiment. It will be understood that various changes may be made in the function and arrangement of elements without departing from the spirit and scope of the invention as set forth in the appended claims. Specific details may also be given in the following description to provide a thorough understanding of possible embodiments. However, it will be understood by one of ordinary skill in the art that the embodiments may be practiced either with, or without, these specific details. One of ordinary skill in the art will also understand that the terms “chair” and “seat” are used interchangeably herein.

In one embodiment, an apparatus for storing objects is provided. The apparatus may include a storage container and an inverted pocket. The storage container may soft or hard sided and may be made from any number of natural and/or synthetic materials known in the art including, but not limited to, natural leather, synthetic leather, animal textiles (i.e. wool and cashmere), plant textiles (i.e. cotton and hemp), and synthetic textiles (i.e. polyester, acrylic, nylon, olefin, and ingeo). The construction of the storage container may also include reinforcement materials to give shape to the container. These reinforcement materials may include, merely by way of example, cardboard, foam, wood, rubber, and synthetic materials such as plastic.

The storage container may define one or more spaces for storing objects. In an embodiment with multiple spaces, each space may be accessible from multiple areas of the container. For example, spaces may be accessible from the sides, top, or bottom of the container. In an embodiment with two or more spaces, a first space may be only nominally separated from the second space, while in other embodiments the spaces may be substantially sealed from each other. For example, in some embodiments, a piece of material, possibly reinforced, may be coupled to the interior corners of the storage container but not coupled along the sides of the interior. In many applications, this may provide sufficient separation between the spaces. In other embodiments however, the piece of material may completely isolate and seal the spaces from each other (though the material may or may not be liquid and/or gas permeable in various embodiments).

In some embodiments, the spaces in the storage container may be accessible via different systems. In some embodiments, zippers, hook-and-loop fasteners (such as Velcro brand fastening systems), and/or other systems known in the art may be used to permit entry into the storage container, and close the storage container after access is complete. In embodiments with multiple spaces within the storage container, different access systems, located in different locations on the surface of the storage container may access different spaces. For example, in one embodiment, a zipper on the top of the storage container may allow access to a first space, while a zipper on the side of the storage container may allow access to a second space. In another embodiment, both the top entry and the side entry may allow access to either space. In embodiments using zippers, each zipper line may have one or two zipper pulls, allowing a user to decide in which position the zipper pulls will close the zipper line.

The inverted pocket may be coupled with the storage container, and may couple the storage container with a chair when at least some portion of the back of the chair is inserted into the inverted pocket. The chair may be a manual wheelchair, an automatic wheelchair, a personal scooter, or any other seat, possibly including, merely by way of example, seats on water craft, golf carts, and/or ride-on lawn mowers. When the inverted pocket is put over the back of a chair, gravity may hold the inverted pocket, as well as the coupled storage container, in place. The inverted pocket may also be fabricated so it is smaller than any anticipated seat back the apparatus may be used on, but made from material or materials which is/are flexible so the inverted pocket may stretch to grip a variety of sized seat backs. In some embodiments, the material or materials may be more flexible in one direction than the other. In all of these or other embodiments, the edge of the inverted pocket may be hemmed with an elastic material that discourages dust, dirt and other undesirables from entering the space between the seat and the pocket.

For example, in an exemplary embodiment, the inverted pocket may be more flexible in a horizontal direction across the width of the seat back than in a direction up-and-down the seat back. This may provide the advantage of securing the inverted pocket to the chair back, but not allowing the weight of the storage container and/or objects within the storage container to cause the inverted pocket to sag in the direction of the weight. Various materials or combination of materials known in the art, may allow for flexibility in one direction, but not in a substantially perpendicular direction.

In some embodiments, at least a portion of the inverted pocket may also be made from a material which wick away moisture. This may be advantageous when used on a portion of the inverted pocket which comes into contact with a user of the chair. In some embodiments at least some portion of the inverted pocket which contacts the back of a user sitting in the chair may be made from a wicking material, thereby advantageously wicking away sweat and other moisture from the user. This is especially advantageous in applications such as wheelchairs and motorized scooters where the user may sit in the chair for extended periods of times. Materials that wick away moisture include, merely by way of example, ingeo.

In some embodiments, one or more tightening mechanisms may be coupled with storage container and the inverted pocket. The mechanism or mechanism may allow a user to tighten the inverted pocket around the back of the chair. In some embodiments, the tightening mechanism may be a strap which may be adjustably tightened. In other embodiments, a draw string with a spring loaded stopper may me employed. The tightening mechanism may advantageously perform at least two functions. First, for seat backs that are smaller than the inverted pocket in its un-stretched state, the tightening mechanism will allow the pocket to still be used and tightened to the size of the seat back. Second, the tightening mechanism may assist in preventing sag of the storage container away from the seat back by providing one or more points where the storage container is tightly secured to the seat back.

In another embodiment, a different apparatus for storing objects is provided. The apparatus may include a storage container and an inverted pocket. The storage container may define at least one space for storing objects. The inverted pocket may be coupled with the storage container, and may couple the storage container with a chair when at least some portion of the back of the chair is inserted into the inverted pocket. The inverted pocket may be at least partially made from a material which is more flexible in a widthwise direction of the chair than in the direction of the depth of the inverted pocket. This embodiment may also have all of, some of, or none of the features discussed in the previous embodiments.

In another embodiment, another apparatus for storing objects is provided. The apparatus may include a storage container and an inverted pocket. The storage container may define at least one space for storing objects. The inverted pocket may be coupled with the storage container, and may couple the storage container with a chair when at least some portion of the back of the chair is inserted into the inverted pocket. At least a portion of the outer side of the inverted pocket may be made from a material which wicks away moisture. This embodiment may also have all of, some of, or none of the features discussed in the previous embodiments.

In a further embodiment, another apparatus for storing objects is provided. The apparatus may include a storage container, an inverted pocket, and at least one tightening mechanism. The storage container may define at least one space for storing objects. The inverted pocket may be coupled with the storage container, and may couple the storage container with a chair when at least some portion of the back of the chair is inserted into the inverted pocket. The tightening mechanism or mechanism may be coupled with the storage container and the inverted pocket, and may allow a user to tighten the inverted pocket in around the back of the chair. This embodiment may also have all of, some of, or none of the features discussed in the previous embodiments.

One skilled in the art will now realize, that some or all of the features of each of the above described embodiments, along with other features, not limited to those described herein, may be combined in various ways to create other embodiments within the scope of the invention. Other features not described at length herein may include pockets on the outside or inside of the storage container made from mesh and/or other materials.

These pockets may be advantageously sized to hold, and provide access to, common consumer electronics devices such as personal music devices, personal data assistants, handheld computers, and mobile phones. As another example, pockets which are sized and shaped to hold laptop or notebook computers may also be employed. Various apertures, possible reinforced (i.e. with metal or plastic eyelets), may also be included to allow microphones and/or earphones to be wired to electronics held within the storage container, but in active use by a user. Smaller loops and or pockets may also be coupled with the interior or exterior of the apparatus to store pencils, pens and other similar sized objects.

Handles on the outside of the apparatus may also allow the apparatus to be carried by hand when not coupled with the chair. In some embodiments, wheels on the bottom of the apparatus, possible on the bottom of the storage container may allow a user to roll the apparatus on the ground, thereby reducing the realized weight of the apparatus and its contents to the user. These or other embodiments may also have fixed length, telescoping, and/or extendable handles.

In some embodiments, apertures on the various portions of the inverted pocket may allow various parts of any given chair to extrude from the pocket. For example, a headrest may require two support shafts to extend from the top of the seat back. The headrest may be removed prior to coupling the apparatus to the seat back, and then reattached through apertures in the top of the pocket.

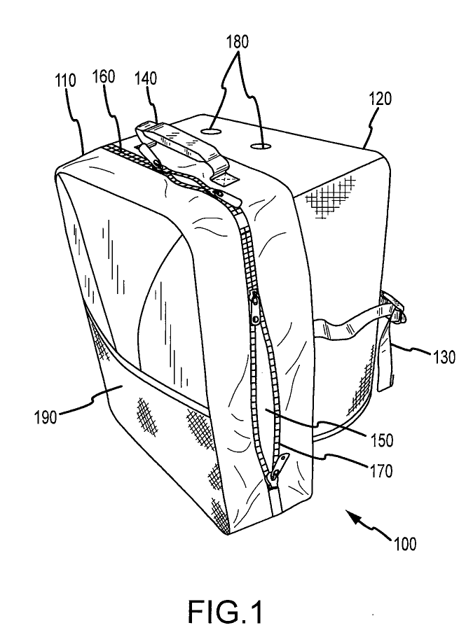

Turning now to FIG. 1, an axonometric drawing of one of the apparatuses 100 of the invention for storing objects is shown. This embodiment of the apparatus includes a storage container 110 and an inverted pocket 120. One of two tightening mechanisms 130 is also seen, with a second tightening mechanism out of view on the reverse side of apparatus 100. A carrying handle 140 is also shown. The interior 150 of storage container 110 may be accessed in this embodiment via a top zipper line 160 and a side zipper line 170. In some embodiments, as discussed above, top zipper line 160 may access a different space inside storage container 110 than side zipper line 170. Apparatus 100 also includes two apertures 180 for a headrest to be used through the inverted pocket 120. Apparatus 100 also includes a pocket 190 on the exterior of storage container 110.

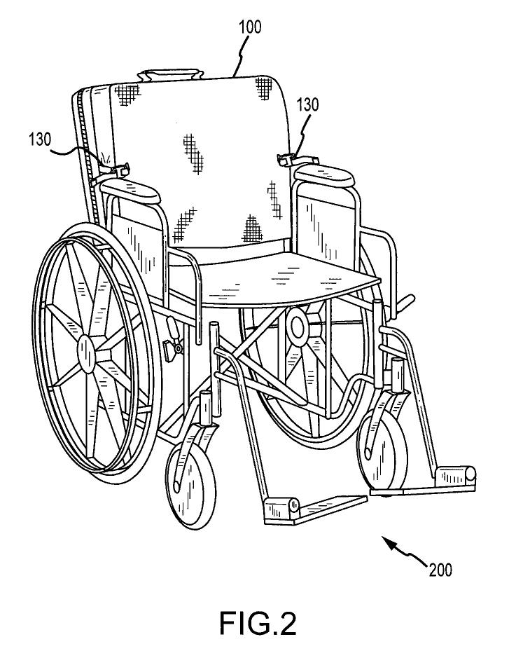

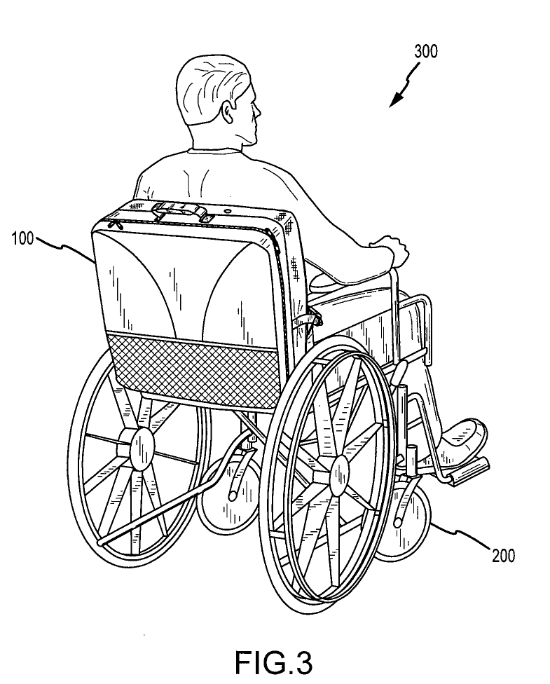

FIG. 2 shows an axonometric drawing of the apparatus 100 of FIG. 1 coupled with a wheelchair 200. In FIG. 2 it may be seen how inverted pocket 120 may be stretched widthwise across the back of the chair to allow it to fit a variety of chair back sizes. Additionally, because inverted pocket 120 is not as flexible in an up-and-down direction as it is in the widthwise direction, the weight of storage container 110 and/or its contents will not cause inverted pocket 120 to sag away from the back of wheelchair 200. After the inverted pocket has been put over the back of the seat, tightening mechanisms 130 may assist in securing apparatus 100 to the seat back. By pulling and tightening the straps of tightening mechanisms 130, any remaining widthwise slack may be removed from inverted pocket 120, particularly in instances where the seat back is contoured in an irregular shape, or is smaller than inverted pocket 120 in its un-stretched shape. Tightening mechanisms 130 may also assist in stabilizing storage container in a lateral direction as well as reduce sag when objects, particularly heavy objects, are stored in the lower portions of storage container 110. FIG. 3 shows a reverse view of FIG. 2 with a person 300 sitting in wheelchair 200 equipped with apparatus 100. It may be seen in this figure how it may be advantageous to use a moisture wicking material on the side of the inverted pocket to draw sweat and other moisture away from user 300 during even short usage periods of wheelchair 200.

The invention has now been described in detail for the purposes of clarity and understanding. However, it will be appreciated that certain changes and modifications may be practiced within the scope of the appended claims.

What is claimed is:

1. An apparatus for storing objects, wherein the apparatus comprises:
a storage container, wherein the storage container defines a plurality of spaces for storing objects including a first space and a second space, and wherein the first space and the second space are each accessible from at least one of a side of the storage container and a top of the storage container; and
an inverted pocket coupled with the storage container, wherein the inverted pocket couples the storage container with a chair when at least some portion of a back of the chair is inserted into the inverted pocket.

2. The apparatus for storing objects of claim 1, wherein the first space is separated from the second space.

3. The apparatus for storing objects of claim 1, wherein the first space is separated and substantially sealed from the second space.

4. The apparatus for storing objects of claim 1, wherein the first space is accessible from the side of the container and the second space is accessible from the top of the container.

5. The apparatus for storing objects of claim 1, wherein the inverted pocket comprises a material which is more flexible in a widthwise direction of the chair than in the direction of a depth of the inverted pocket.

6. The apparatus for storing objects of claim 1, wherein at least a portion of an outer side of the inverted pocket comprises a material which wicks away moisture.

7. The apparatus for storing objects of claim 1, further comprising at least one tightening mechanism coupled with the storage container and the inverted pocket, wherein the tightening mechanism allows a user to tighten the inverted pocket around the back of the chair.

8. An apparatus for storing objects, wherein the apparatus comprises:
a storage container, wherein the storage container defines at least one space for storing objects; and
an inverted pocket coupled with the storage container, wherein the inverted pocket couples the storage container with a chair when at least some portion of a back of the chair is inserted into the inverted pocket, and wherein the inverted pocket comprises a material which is more flexible in a widthwise direction of the chair than in the direction of a depth of the inverted pocket.

9. The apparatus for storing objects of claim 8, wherein the at least one space includes a first space and a second space, and wherein the first space and the second space are each accessible from at least one of a side of the storage container and a top of the storage container.

10. The apparatus for storing objects of claim 9, wherein the first space is separated from the second space.

11. The apparatus for storing objects of claim 9, wherein the first space is separated and substantially sealed from the second space.

12. The apparatus for storing objects of claim 9, wherein the first space is accessible from the side of the container and the second space is accessible from the top of the container.

13. The apparatus for storing objects of claim 8, wherein at least a portion of an outer side of the inverted pocket comprises a material which wicks away moisture.

14. The apparatus for storing objects of claim 8, further comprising at least one tightening mechanism coupled with the storage container and the inverted pocket, wherein the tightening mechanism allows a user to tighten the inverted pocket around the back of the chair.

15. An apparatus for storing objects, wherein the apparatus comprises:
a storage container, wherein the storage container defines at least one space for storing objects; and
an inverted pocket coupled with the storage container, wherein the inverted pocket couples the storage container with a chair when at least some portion of a back of the chair is inserted into the inverted pocket, and wherein at least a portion of an outer side of the inverted pocket comprises a material which wicks away moisture.

16. The apparatus for storing objects of claim 15, wherein the at least one space includes a first space and a second space, and wherein the first space and the second space are each accessible from at least one of a side of the storage container and a top of the storage container.

17. The apparatus for storing objects of claim 16, wherein the first space is separated from the second space.

18. The apparatus for storing objects of claim 16, wherein the first space is separated and substantially sealed from the second space.

19. The apparatus for storing objects of claim 16, wherein the first space is accessible from the side of the container and the second space is accessible from the top of the container.

20. The apparatus for storing objects of claim 15, wherein the inverted pocket comprises a material which is more flexible in a widthwise direction of the chair than in the direction of a depth of the inverted pocket.
